(19) United States
(12) Patent Application Publication
(10) Pub. No.: US 2024/0205351 A1
(43) Pub. Date: Jun. 20, 2024

(54) PROCESSING APPARATUS, PROCESSING METHOD, AND NON-TRANSITORY COMPUTER READABLE MEDIUM STORING PROCESSING PROGRAM

(71) Applicant: FUJIFILM Business Innovation Corp., Tokyo (JP)

(72) Inventor: Minoru AKIYAMA, Kenagawa (JP)

(73) Assignee: FUJIFILM Business Innovation Corp., Tokyo (JP)

(21) Appl. No.: 18/320,213

(22) Filed: May 19, 2023

(30) Foreign Application Priority Data
Dec. 15, 2022 (JP) 2022-200199

(51) Int. Cl. H04N 1/32; H04N 1/00

(52) U.S. Cl. CPC H04N 1/32635; H04N 1/00015; H04N 1/00037

(57) ABSTRACT

A processing apparatus includes: a processor configured to: acquire, in a case where plural processes having different required times and accompanied by operating sounds are continuously executed, data representing a collection result of the operating sounds; derive the number of pieces of data in a case where the data is subjected to frequency analysis from an operating condition; reduce analysis result data of the derived number of pieces of data after the frequency analysis to the number of pieces of data with which a detection process of an abnormal sound is performable within a processing time for processing a next processing target; and detect the abnormal sound by using the reduced analysis result data.

### CROSS-REFERENCE TO RELATED APPLICATIONS

This application is based on and claims priority under 35 USC 119 from Japanese Patent Application No. 2022-200199 filed Dec. 15, 2022.

### BACKGROUND

### (i) Technical Field

The present invention relates to a processing apparatus, a processing method, and a non-transitory computer readable medium storing a processing program.

### (ii) Related Art

In JP4929049B, there is proposed an image processing apparatus including a sound conversion unit that converts a sound inside the apparatus into an electric signal, a sound analysis unit that analyzes the electric signal converted by the sound conversion unit to obtain a component for each frequency, and an output unit that outputs the component obtained for each frequency.

In JP2021-163387A, an abnormality determination unit compares a spectrogram in which sound data collected by a sound collection microphone when an image forming apparatus operates at a low speed is frequency-analyzed with a normal spectrogram when the image forming apparatus normally operates at the low speed. In a case where it is determined that an abnormal sound is generated, an operating body that is a generation source of the abnormal sound can be specified by comparing a timing chart of the operating body when the image forming apparatus operates at the low speed with a spectrogram output by a frequency analysis unit.

In JP2020-172861A, there is proposed an abnormality discrimination apparatus that continuously clips, from image data obtained by frequency-analyzing time-series sound data generated from a blade used for a wind turbine, the image data at time intervals for one rotation of the wind turbine, generates image data that is scaled and superimposed to have the same width in a time axis direction of the clipped image data with respect to image data as a reference in the continuous clipped image data, and learns the generated image data.

### SUMMARY

In a case where an abnormal sound is detected by collecting an operating sound when a plurality of processes having different required times and accompanied by an operating sound are continuously executed, an analysis time required for an analysis of one abnormal sound is different according to an operating condition of a processing target, so that a productivity may be decreased. For example, in a case where an image forming apparatus forms an image on a first sheet as a processing target and then forms an image on a sheet of a size smaller than the first sheet, an analysis time required for an analysis of an abnormal sound during transportation of the first sheet may be longer than a time for collecting an operating sound during transportation of the second sheet, that is, a transportation time of the second sheet. Here, in a case where the analysis time of the first sheet is not completed, a memory cannot be released, and the process cannot move to the analysis of the second sheet. In a case where the analysis cannot be performed on the second sheet, the process such as image formation on a third sheet cannot be performed. As described above, in a case where a time during which the process for the objects to be transported cannot be performed occurs, the productivity is reduced by the amount of the processes that cannot be performed.

Aspects of non-limiting embodiments of the present disclosure relate to a processing apparatus, a processing method, and a non-transitory computer readable medium storing a processing program that detect an abnormal sound without reducing productivity in a case where a plurality of processes having different required times and accompanied by an operating sound are continuously executed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a processing apparatus including: a processor configured to: acquire, in a case where a plurality of processes having different required times and accompanied by operating sounds are continuously executed, data representing a collection result of the operating sounds; derive the number of pieces of data in a case where the data is subjected to frequency analysis from an operating condition; reduce analysis result data of the derived number of pieces of data after the frequency analysis to the number of pieces of data with which a detection process of an abnormal sound is performable within a processing time for processing a next processing target; and detect the abnormal sound by using the reduced analysis result data.

### BRIEF DESCRIPTION OF THE DRAWINGS

Exemplary embodiment(s) of the present invention will be described in detail based on the following figures, wherein:

FIG. 1 is a block diagram illustrating a schematic configuration of an image forming apparatus according to the present exemplary embodiment;

FIG. 2 is a diagram illustrating a calculation example of the number of times of executing a frequency analysis;

FIG. 3 is a flowchart illustrating an example of a flow of processes performed by a processor of the image forming apparatus according to the present exemplary embodiment as an abnormal sound detection control unit;

FIG. 4 is a flowchart illustrating an example of a flow of processes performed by a processor of the image forming apparatus according to the exemplary embodiment as a sound sensor control unit;

FIG. 5 is a flowchart illustrating an example of a flow of processes performed by the processor of the image forming apparatus according to the present exemplary embodiment as a frequency analysis unit;

FIG. 6 is a flowchart illustrating an example of a flow of processes performed by the processor of the image forming apparatus according to the present exemplary embodiment as a reduction processing unit;

FIG. 7 is a flowchart illustrating an example of a flow of processes performed by the processor of the image forming apparatus according to the present exemplary embodiment as an abnormal sound determination unit;

FIG. 8 is a flowchart illustrating an example of a flow of processes performed by the processor of the image forming apparatus according to the present exemplary embodiment as an abnormal sound detection control unit in a case where an occurrence of an abnormal sound is notified; and

FIG. 9 is a diagram illustrating a result of respective comparisons between a case 1 where the exemplary embodiment is not implemented, a case 2 where the present exemplary embodiment is not implemented, and a case where the present exemplary embodiment is implemented.

### DETAILED DESCRIPTION

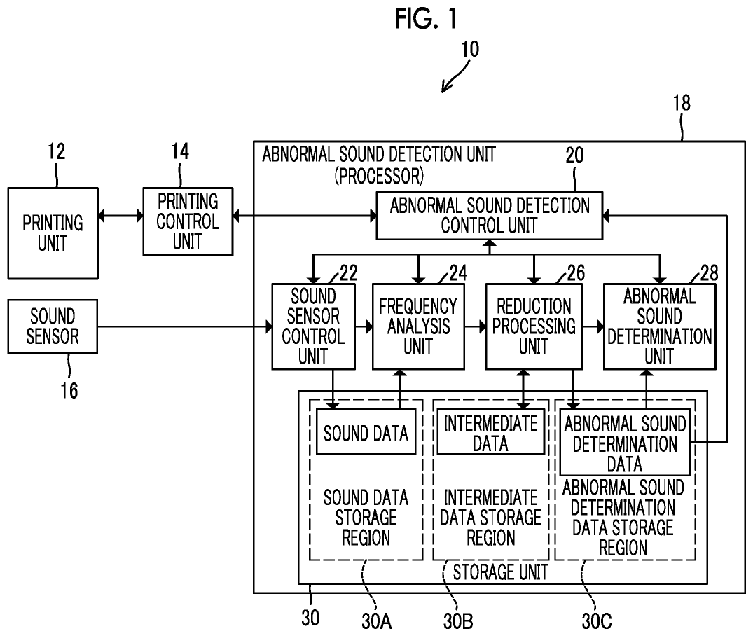

Hereinafter, an example of exemplary embodiments of the present disclosure will be described in detail with reference to the drawings. In the present exemplary embodiment, an image forming apparatus will be described as an example of a processing apparatus. FIG. 1 is a block diagram illustrating a schematic configuration of an image forming apparatus according to the present exemplary embodiment.

As illustrated in FIG. 1, an image forming apparatus 10 according to the present exemplary embodiment includes a printing unit 12, a printing control unit 14, a sound sensor 16, and a processor 18.

The printing unit 12 continuously executes a plurality of processes having different required times and accompanied by an operating sound. An example of the plurality of processes includes a process of transporting recording paper to the printing unit 12, a process of printing, a process of outputting the printed recording paper, and the like. Specifically, the printing unit 12 has an electrophotographic printing mechanism, a transport mechanism for recording paper, and the like. In a case where image data indicating an image to be printed and various operation commands are input from the printing control unit 14, the printing unit 12 performs a print on one side or both sides of the recording paper and outputs the recording paper to an external paper output tray.

The printing control unit 14 outputs the image data and the various operation commands to the printing unit 12, and performs control and the like of an operation of the printing unit 12.

The sound sensor 16 collects an operating sound generated in relation to printing. That is, an operating sound generated by the image forming apparatus 10 during printing by the printing mechanism, the transport mechanism, or the like of the printing unit 12 is collected.

The processor 18 acquires data representing a collection result of the operating sound of the printing unit 12, derives the number of pieces of data in a case where the acquired data is frequency-analyzed according to operating conditions, reduces the data after the frequency analysis so that the derived number of pieces of data becomes the number of pieces of data with which an abnormal sound detection process can be performed within a processing time for processing the next processing target, and uses the reduced data to perform a process of detecting an abnormal sound. In the present exemplary embodiment, the processor 18 functions as an abnormal sound detection unit 18, and the abnormal sound detection unit 18 makes a size of abnormal sound determination data used for the process constant to make the processing time for determining the abnormal sound constant. In order to make the size of the abnormal sound determination data constant, the data obtained as a result of frequency analysis of the sound data from the sound sensor 16 is reduced to a constant size, and the abnormal sound is determined.

Specifically, the abnormal sound detection unit 18 has functions of an abnormal sound detection control unit 20, a sound sensor control unit 22, a frequency analysis unit 24, a reduction processing unit 26, an abnormal sound determination unit 28, and a storage unit 30.

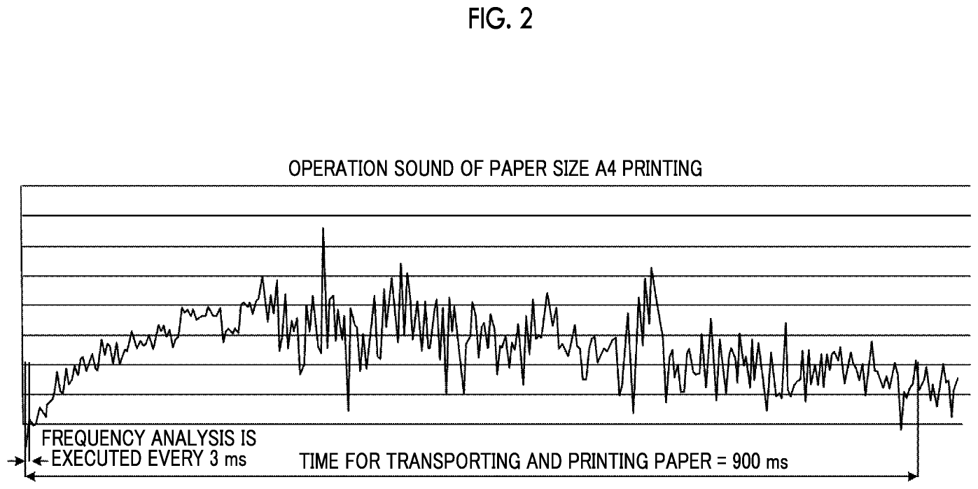

The abnormal sound detection control unit 20 calculates the number of pieces of data in a case where data of the collected operating sound is frequency-analyzed according to the operating conditions. Specifically, in a case where the printing control unit 14 notifies the operating condition such as a paper size or a paper transporting speed included in a printing condition instructed as a printing process, the abnormal sound detection control unit 20 calculates the number of times of executing a frequency analysis under the operating conditions. For example, as illustrated in FIG. 2, when it is defined to execute the frequency analysis every 3 ms, in a case where recording paper has an A4 size, a time for transporting and printing the paper is 900 ms, so that the frequency analysis is executed 900 ms/3 ms=300 times. The number of times of executing the frequency analysis is determined from a time required for the printing process per recording paper. In a case where the number of times of executing the frequency analysis in printing of the recording paper of the size A4 is 300, a length of the paper is twice a length of A4 in printing of paper of a size A3, so that a time required for the paper to be transported and printed is 1800 ms. Therefore, the processing time for printing is doubled, and the number of times of executing the frequency analysis is 600. In this manner, the number of times of executing the frequency analysis can be determined depending on the operating conditions. The abnormal sound detection control unit 20 notifies the reduction processing unit 26 of the number of times of executing the frequency analysis and the number of times corresponding to the data size defined as the abnormal sound determination data, sets the number of times of executing the frequency analysis to the sound sensor control unit 22, and notifies the sound sensor control unit 22 to start collecting sound data.

In a case where the sound sensor control unit 22 notifies the frequency analysis unit 24 of the start of collection of the sound data from the abnormal sound detection control unit 20, the sound sensor control unit 22 sets an output counter for counting the number of times a frequency analysis request is notified to the frequency analysis unit 24 to 0. The sound data from the sound sensor 16 is acquired and written in a sound data storage region 30A of the storage unit 30. In a case where the sound data for one frequency analysis is written in the sound data storage region 30A of the storage unit 30, the frequency analysis unit 24 is notified of the frequency analysis request, and the output counter is counted up. This is repeated until a value of the output counter coincides with the number of times of executing the frequency analysis.

In a case where the frequency analysis request is notified from the sound sensor control unit 22, the frequency analysis unit 24 reads the sound data from the sound data storage region 30A of the storage unit 30, performs a frequency analysis, outputs analysis result data to the reduction processing unit 26, and notifies the reduction processing unit 26 of a reduction request of the sound data. This analysis result data is data indicating a sound pressure for each frequency as an example.

The reduction processing unit 26 acquires the analysis result data analyzed by the frequency analysis unit 24, and performs a process of reducing a data size of abnormal sound determination data to make the data size constant. For example, in a case of a printing process of paper of a size A3, 600 pieces of analysis result data are acquired, and a process of reducing the analysis result data to 300 pieces of analysis result data is performed. The data obtained by reducing a group of the pieces of analysis result data is stored as the abnormal sound determination data in an abnormal sound determination data storage region 30C of the storage unit 30, and the abnormal sound determination unit 28 is notified of an abnormal sound determination request. As an example, in a case where two pieces of data are set as one piece of data in a case where 600 pieces are set as 300 pieces, a method of reducing data by the reduction processing unit 26 reduces data by any of the following methods.
Thinning: an odd-th analysis result or an even-th analysis result is adopted as abnormal sound determination data.
Averaging: an average value of the two analysis results is used as abnormal sound determination data.
Comparison: a larger value of the two analysis results is adopted as abnormal sound determination data.

In a case where averaging or comparison is applied as the reduction processing method of the reduction processing unit 26, sound data to be compared or sound data to be averaged is stored as intermediate data in an intermediate data storage region 30B of the storage unit 30, and averaging or comparison is performed. Further, although the example in which two pieces of data are set as one piece of data is described here as the reduction method of the reduction processing unit 26, the present exemplary embodiment is not limited to this, and three or more pieces of data may be set as one piece of data. In addition, the reduction may be performed according to a ratio between a data size of a reduction target and a data size defined as abnormal sound determination data. Further, in the present exemplary embodiment, the number of pieces of data is reduced in accordance with a size of the recording paper in which the number of pieces of data is small, and the present invention is not limited to this. For example, the data size may be reduced in accordance with the most commonly printed size, such as an A4 size.

In a case where the abnormal sound determination request is notified from the reduction processing unit 26, the abnormal sound determination unit 28 reads the abnormal sound determination data from the abnormal sound determination data storage region 30C of the storage unit 30. The presence or absence of an abnormal sound is determined based on operating conditions added to the abnormal sound determination request from the reduction processing unit 26 and the abnormal sound determination data. In a case where there is the abnormal sound, the abnormal sound detection control unit 20 is notified of the occurrence of the abnormal sound.

In a case where occurrence of an abnormal sound is notified from the abnormal sound determination unit 28, the abnormal sound detection control unit 20 notifies the printing control unit 14 of the occurrence of the abnormal sound. Further, in order to specify a cause of the abnormal sound, the abnormal sound determination data is read from the abnormal sound determination data storage region 30C of the storage unit 30, and output to the printing control unit 14.

Subsequently, a specific process performed by the processor 18 of the image forming apparatus 10 according to the present exemplary embodiment configured as described above will be described.

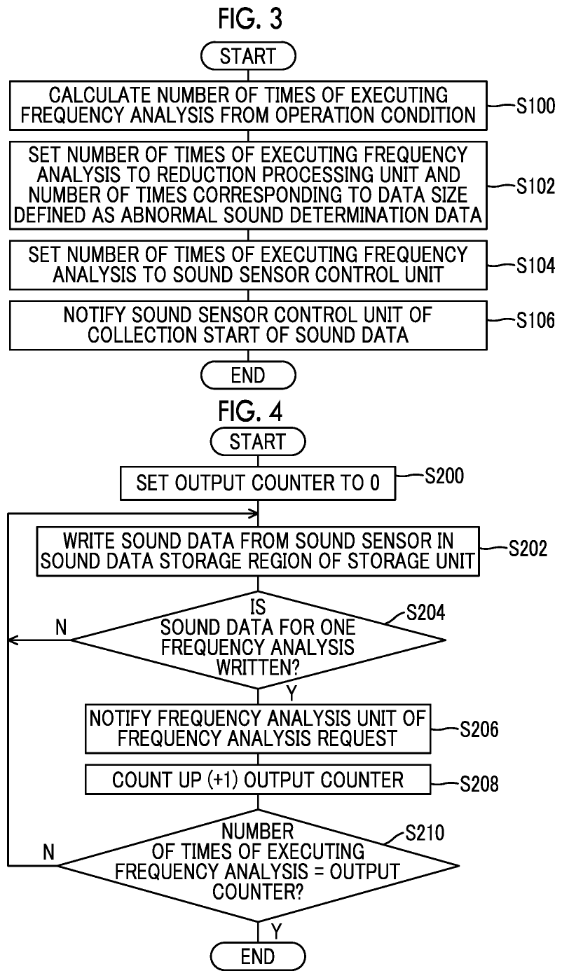

First, a process of the abnormal sound detection control unit 20 will be described. FIG. 3 is a flowchart illustrating an example of a flow of processes performed by the processor 18 of the image forming apparatus 10 according to the present exemplary embodiment as the abnormal sound detection control unit 20. The process in FIG. 3 is started in a case where the printing control unit 14 notifies an operating condition and position information of recording paper.

In step S100, the abnormal sound detection control unit 20 calculates the number of times of executing a frequency analysis from the operating conditions notified from the printing control unit 14, and proceeds to step S102. For example, as illustrated in FIG. 2, in a case where the frequency analysis is executed every 3 ms, in a case where recording paper has an A4 size, a time for transporting and printing the paper is 900 ms, so that the frequency analysis is executed 900 ms/3 ms=300 times.

In step S102, the abnormal sound detection control unit 20 sets the number of times of executing the frequency analysis to the reduction processing unit 26 and the number of times corresponding to a data size defined as abnormal sound determination data, and proceeds to step S104.

In step S104, the abnormal sound detection control unit 20 sets the number of times of executing the frequency analysis to the sound sensor control unit 22, and proceeds to step S106.

In step S106, the abnormal sound detection control unit 20 notifies the sound sensor control unit 22 of a start of collection of sound data, and ends a series of processes of the abnormal sound detection control unit 20.

Next, a process of the sound sensor control unit 22 will be described. FIG. 4 is a flowchart illustrating an example of a flow of processes performed by the processor 18 of the image forming apparatus 10 according to the present exemplary embodiment as the sound sensor control unit 22. The process in FIG. 4 is started in a case where the abnormal sound detection control unit 20 notifies a start of collection of sound data.

In step S200, the sound sensor control unit 22 sets an output counter to 0, and proceeds to step S202.

In step S202, the sound sensor control unit 22 writes the sound data from the sound sensor 16 in the sound data storage region 30A of the storage unit 30, and proceeds to step S204.

In step S204, the sound sensor control unit 22 determines whether or not the sound data for one frequency analysis is written. In a case where the determination is negative, the process is returned to step S202, and the process described above is repeated. In a case where the determination is positive, the process proceeds to step S206.

In step S206, the sound sensor control unit 22 notifies the frequency analysis unit 24 of a frequency analysis request, and the process proceeds to step S208.

In step S208, the sound sensor control unit 22 counts up (+1) the output counter, and proceeds to step S210.

In step S210, the sound sensor control unit 22 determines whether or not the number of times of executing the frequency analysis=the output counter. In a case where the determination is negative, the process is returned to step S202, and the process described above is repeated. In a case where the determination is positive, the process of the sound sensor control unit 22 is ended.

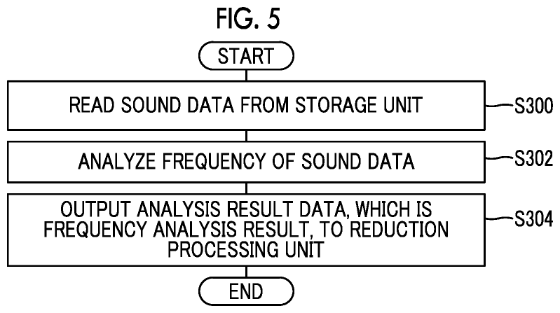

Next, a process of the frequency analysis unit 24 will be described. FIG. 5 is a flowchart illustrating an example of a flow of processes performed by the processor 18 of the image forming apparatus 10 according to the present exemplary embodiment as the frequency analysis unit 24. The process in FIG. 5 is started in a case where the sound sensor control unit 22 notifies a frequency analysis request.

In step S300, the frequency analysis unit 24 reads sound data from the sound data storage region 30A of the storage unit 30, and proceeds to step S302.

In step S302, the frequency analysis unit 24 performs a frequency analysis on the sound data, and proceeds to step S304.

In step S304, the frequency analysis unit 24 outputs analysis result data, which is a frequency analysis result, to the reduction processing unit 26, and ends a series of processes of the frequency analysis unit 24.

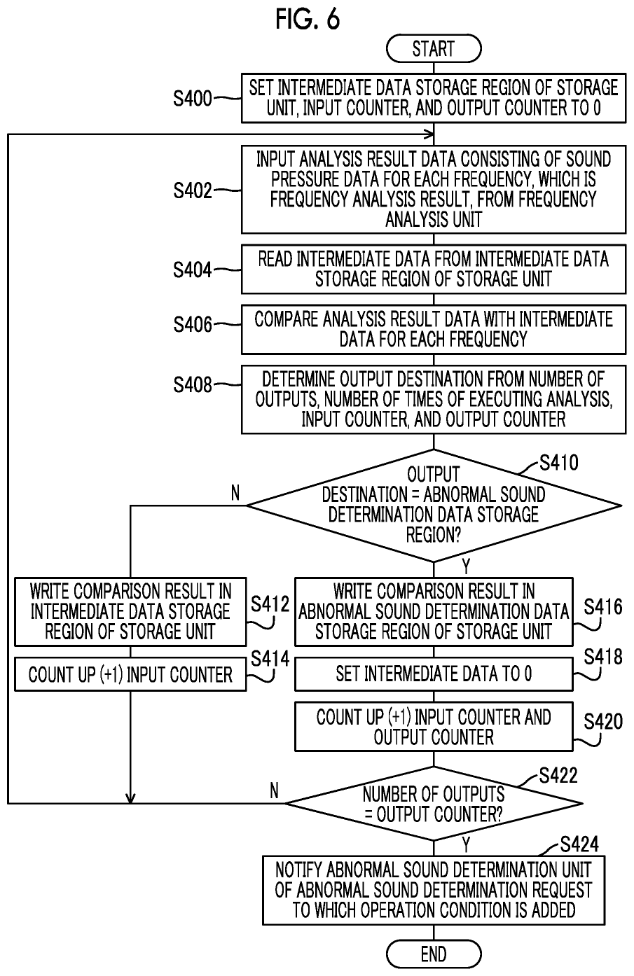

Next, a process of the reduction processing unit 26 will be described. FIG. 6 is a flowchart illustrating an example of a flow of processes performed by the processor 18 of the image forming apparatus 10 according to the present exemplary embodiment as the reduction processing unit 26. The process in FIG. 6 will be described as an example in a case where comparison is applied as a reduction processing method. Further, the process in FIG. 6 is started in a case where the abnormal sound detection control unit 20 sets the number of times corresponding to a data size defined as abnormal sound determination data and the number of times of executing an analysis.

In step S400, the reduction processing unit 26 sets the intermediate data storage region 30B of the storage unit 30, an input counter, and an output counter to 0, and proceeds to step S402.

In step S402, the reduction processing unit 26 inputs analysis result data consisting of sound pressure data for each frequency, which is a frequency analysis result, from the frequency analysis unit 24, and proceeds to step S404.

In step S404, the reduction processing unit 26 reads intermediate data from the intermediate data storage region 30B of the storage unit 30, and proceeds to step S406.

In step S406, the reduction processing unit 26 compares the analysis result data with the intermediate data for each frequency, and proceeds to step S408. For example, a larger value of the two analysis results is used as the abnormal sound determination data.

In step S408, the reduction processing unit 26 determines an output destination from the number of outputs, the number of times of executing the analysis, the input counter, and the output counter, and proceeds to step S410.

In step S410, the reduction processing unit 26 determines whether or not the output destination=the abnormal sound determination data storage region 30C. In a case where the determination is negative, the process proceeds to step S412, and in a case where the determination is positive, the process proceeds to step S416.

In step S412, the reduction processing unit 26 writes a comparison result in the intermediate data storage region 30B of the storage unit 30, and proceeds to step S414.

In step S414, the reduction processing unit 26 counts up (+1) the input counter, and proceeds to step S402.

On the other hand, in step S416, the reduction processing unit 26 writes the comparison result in the abnormal sound determination data storage region 30C of the storage unit 30, and proceeds to step S418.

In step S418, the reduction processing unit 26 sets the intermediate data to 0, and proceeds to step S420.

In step S420, the reduction processing unit 26 counts up (+1) the input counter and the output counter, and proceeds to step S422.

In step S422, the reduction processing unit 26 determines whether or not the number of outputs=the output counter. In a case where the determination is negative, the process returns to step S402, and the process described above is repeated. In a case where the determination is positive, the process proceeds to step S424.

In step S424, the reduction processing unit 26 notifies the abnormal sound determination unit 28 of an abnormal sound determination request to which an operating condition is added, and ends a series of processes of the reduction processing unit 26.

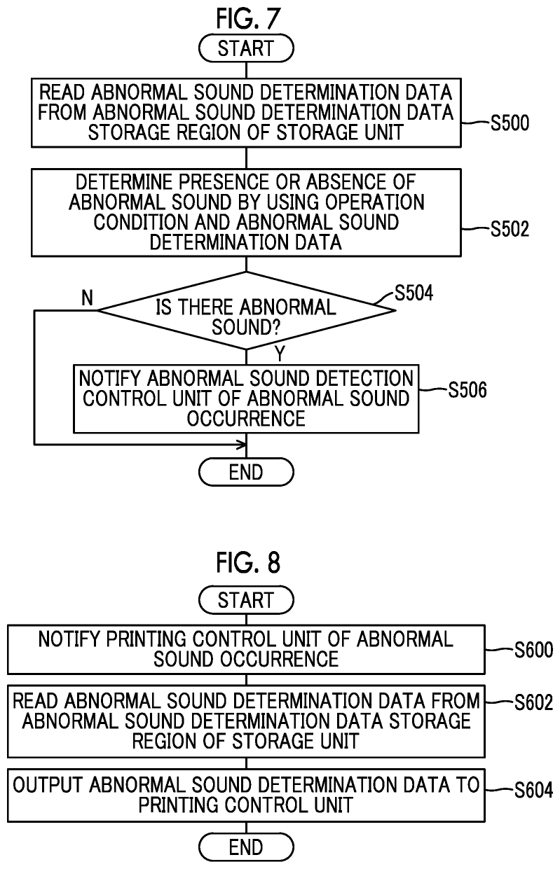

Next, a process of the abnormal sound determination unit 28 will be described. FIG. 7 is a flowchart illustrating an example of a flow of processes performed by the processor 18 of the image forming apparatus 10 according to the present exemplary embodiment as the abnormal sound determination unit 28. The process in FIG. 7 is started in a case where the reduction processing unit 26 notifies an abnormal sound determination request.

In step S500, the abnormal sound determination unit 28 reads abnormal sound determination data from the abnormal sound determination data storage region 30C of the storage unit 30, and proceeds to step S502.

In step S502, the abnormal sound determination unit 28 determines the presence or absence of an abnormal sound by using an operating condition and the abnormal sound determination data, and proceeds to step S504. The presence or absence of the abnormal sound is determined by using a well-known technology. For example, the occurrence of the abnormal sound may be determined by performing a Fourier transform such as a short-time Fourier transform to image frequency characteristics and comparing the image with a reference image prepared in advance. The presence or absence of the occurrence of the abnormal sound may be determined by using an abnormal sound determination model created by creating an abnormal sound determination model by performing machine learning on normal data obtained by imaging frequency characteristics.

In step S504, the abnormal sound determination unit 28 determines whether or not there is an abnormal sound. In a case where there is an abnormal sound and the determination is positive, the process proceeds to step S506, and in a case where the determination is negative, a series of processes of the abnormal sound determination unit 28 is ended.

In step S506, the abnormal sound determination unit 28 notifies the abnormal sound detection control unit 20 of the occurrence of the abnormal sound, and ends a series of processes of the abnormal sound determination unit 28.

Next, a process of the abnormal sound detection control unit 20 will be described. FIG. 8 is a flowchart illustrating an example of a flow of processes performed by the processor 18 of the image forming apparatus 10 according to the present exemplary embodiment as the abnormal sound detection control unit 20 in a case where occurrence of an abnormal sound is notified. The process in FIG. 8 is started in a case where the abnormal sound determination unit 28 notifies the occurrence of the abnormal sound.

In step S600, the abnormal sound detection control unit 20 notifies the printing control unit 14 of the occurrence of the abnormal sound, and the process proceeds to step S602.

In step S602, the abnormal sound detection control unit 20 reads abnormal sound determination data from the abnormal sound determination data storage region 30C of the storage unit 30, and proceeds to step S604.

In step S604, the abnormal sound detection control unit 20 outputs the abnormal sound determination data to the printing control unit 14, and ends a series of processes of the abnormal sound detection control unit 20.

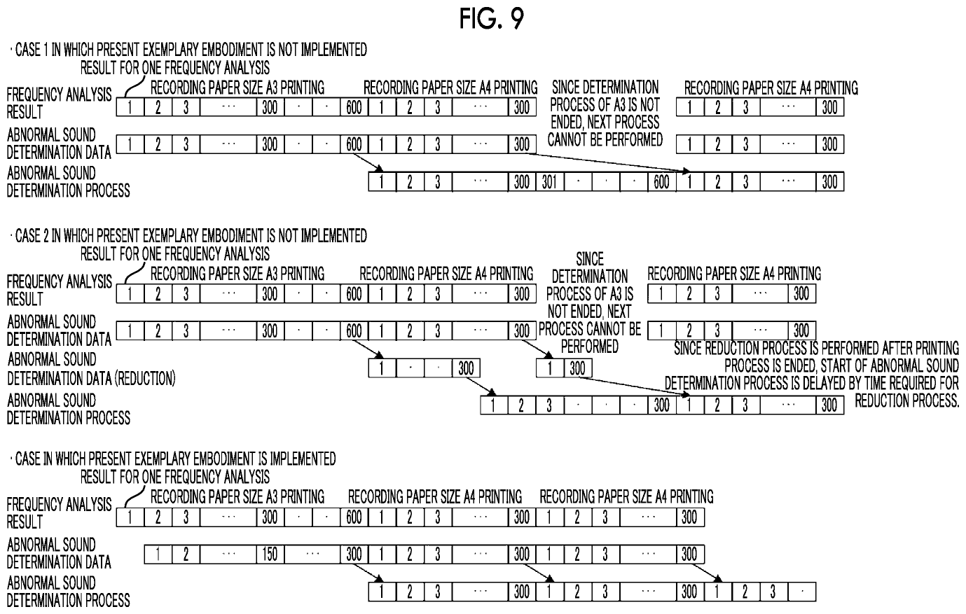

FIG. 9 illustrates results of respective comparisons between a case 1 where the present exemplary embodiment is not implemented, a case 2 where the present exemplary embodiment is not implemented, and a case where the present exemplary embodiment is implemented. In the example in FIG. 9, a case of printing in an order of recording paper sizes A3, A4, and A4 is illustrated.

The case 1 in which the present exemplary embodiment is not implemented is a case in which a reduction process is not implemented. In this case, a result of a frequency analysis of A3 is 600, and a result of a frequency analysis of A4 is 300. Therefore, as illustrated in FIG. 9, a determination process of A3 is not ended, so that the next process cannot be performed, and a waiting time occurs.

In addition, the case 2 in which the present exemplary embodiment is not implemented is a case where the reduction processes are collectively performed. In the same manner, in this case as well, the determination process of A3 is not ended, so that the next process cannot be performed and a waiting time occurs.

On the other hand, in the case where the present exemplary embodiment is implemented, the reduction process is sequentially performed and an abnormal sound determination process is performed, so that a waiting time is eliminated.

In the exemplary embodiment described above, the image forming apparatus 10 is described as an example of a processing apparatus, and the processing apparatus is not limited to the image forming apparatus 10. For example, an image processing apparatus, a transport apparatus that transports various objects to be transported, or any other processing apparatus may be used as long as the apparatus continuously executes a plurality of processes having different required times and accompanied by an operating sound.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In addition, the process performed by the processor 18 according to the exemplary embodiment described above may be a process performed by software, a process performed by hardware, or a process in which both are combined. Further, the process performed by the processor 18 may be stored as a program in a storage medium and distributed.

In addition, the present disclosure is not limited to the above description, and various modifications other than the above description may be made without departing from the gist thereof.

Regarding the above exemplary embodiment, the following supplementary notes are further disclosed.

(((1)))

A processing apparatus comprising:
a processor configured to:
   acquire, in a case where a plurality of processes having different required times and accompanied by operating sounds are continuously executed, data representing a collection result of the operating sounds;
   derive the number of pieces of data in a case where the data is subjected to frequency analysis from an operating condition;
   reduce analysis result data of the derived number of pieces of data after the frequency analysis to the number of pieces of data with which a detection process of an abnormal sound is performable within a processing time for processing a next processing target; and
   detect the abnormal sound by using the reduced analysis result data.

(((2)))

The processing apparatus according to (((1))), wherein the processor is configured to:
acquire data representing a collection result of operating sounds generated in relation to printing as the operating sounds.

(((3)))

The processing apparatus according to (((1))) or (((2))), wherein the processor is configured to:
reduce the analysis result data by thinning out the analysis result data after the frequency analysis.

(((4)))

The processing apparatus according to (((1))) or (((2))), wherein the processor is configured to:
reduce the analysis result data by averaging a plurality of pieces of analysis result data after the frequency analysis.

(((5)))

The processing apparatus according to (((1))) or (((2))), wherein the processor is configured to:
reduce the analysis result data by comparing two pieces of analysis result data after the frequency analysis and adopting the data having a larger value.

(((6)))

A processing method performed by a computer, the method comprising:
acquiring, in a case where a plurality of processes having different required times and accompanied by operating sounds are continuously executed, data representing a collection result of the operating sounds;
deriving the number of pieces of data in a case where the data is subjected to frequency analysis from an operating condition;
reducing analysis result data of the derived number of pieces of data after the frequency analysis to the number of pieces of data with which a detection process of an abnormal sound is performable within a processing time for processing a next processing target; and
detecting the abnormal sound by using the reduced analysis result data.

(((7)))

A non-transitory computer readable medium storing a processing program causing a computer to execute a process comprising:
acquiring, in a case where a plurality of processes having different required times and accompanied by operating sounds are continuously executed, data representing a collection result of the operating sounds;
deriving the number of pieces of data in a case where the data is subjected to frequency analysis from an operating condition;
reducing analysis result data of the derived number of pieces of data after the frequency analysis to the number of pieces of data with which a detection process of an abnormal sound is performable within a processing time for processing a next processing target; and
detecting the abnormal sound by using the reduced analysis result data.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A processing apparatus comprising:
a processor configured to:
acquire, in a case where a plurality of processes having different required times and accompanied by operating sounds are continuously executed, data representing a collection result of the operating sounds;
derive the number of pieces of data in a case where the data is subjected to frequency analysis from an operating condition;
reduce analysis result data of the derived number of pieces of data after the frequency analysis to the number of pieces of data with which a detection process of an abnormal sound is performable within a processing time for processing a next processing target; and
detect the abnormal sound by using the reduced analysis result data.

2. The processing apparatus according to claim 1, wherein the processor is configured to:
acquire data representing a collection result of operating sound generated in relation to printing as the operating sounds.

3. The processing apparatus according to claim 1, wherein the processor is configured to:
reduce the analysis result data by thinning out the analysis result data after the frequency analysis.

4. The processing apparatus according to claim 1, wherein the processor is configured to:
reduce the analysis result data by averaging a plurality of pieces of analysis result data after the frequency analysis.

5. The processing apparatus according to claim 1, wherein the processor is configured to:
reduce the analysis result data by comparing two pieces of analysis result data after the frequency analysis and adopting the data having a larger value.

6. A processing method performed by a computer, the method comprising:
acquiring, in a case where a plurality of processes having different required times and accompanied by operating sounds are continuously executed, data representing a collection result of the operating sounds;
deriving the number of pieces of data in a case where the data is subjected to frequency analysis from an operating condition;
reducing analysis result data of the derived number of pieces of data after the frequency analysis to the number of pieces of data with which a detection process of an abnormal sound is performable within a processing time for processing a next processing target; and
detecting the abnormal sound by using the reduced analysis result data.

7. A non-transitory computer readable medium storing a processing program causing a computer to execute a process comprising:
acquiring, in a case where a plurality of processes having different required times and accompanied by operating sounds are continuously executed, data representing a collection result of the operating sounds;
deriving the number of pieces of data in a case where the data is subjected to frequency analysis from an operating condition;
reducing analysis result data of the derived number of pieces of data after the frequency analysis to the number of pieces of data with which a detection process of an abnormal sound is performable within a processing time for processing a next processing target; and
detecting the abnormal sound by using the reduced analysis result data.
